(19) United States
(12) Patent Application Publication
(10) Pub. No.: US 2013/0048234 A1
(43) Pub. Date: Feb. 28, 2013

(54) DUAL DRUM LIFT MECHANISM FOR VENETIAN BLINDS

(71) Applicants: Svend-Erik Paulsen Dahl, Hedehusene (DK); Jakob Dydensborg, Borre (DK)

(72) Inventors: Svend-Erik Paulsen Dahl, Hedehusene (DK); Jakob Dydensborg, Borre (DK)

(73) Assignee: JORN KRAB HOLDING APS, Copenhagen V. (DK)

(21) Appl. No.: 13/583,791

(22) PCT Filed: Mar. 8, 2011
(86) PCT No.: PCT/EP11/53443

§ 371 Date: Nov. 16, 2012

(30) Foreign Application Priority Data
Mar. 10, 2010 (DK) PA 2010 00193
Mar. 10, 2010 (DK) PA 2010 00194
Mar. 10, 2010 (DK) PA 2010 00195
Mar. 10, 2010 (DK) PA 2010 00196
Mar. 11, 2010 (DK) PA 2010 00197
Aug. 23, 2010 (EP) 10173684.1

(51) Int. Cl. E06B 9/322; E06B 9/38

(52) U.S. Cl. 160/171; 160/178.1 R; 160/170

(57) ABSTRACT

The present invention relates to a very flexible Venetian blind that easily can be adapted to various sizes of for instance window openings, by a person having limited skill in mounting and adapting Venetian blinds. Also the Venetian blind according to the invention is designed such that individual slats can easily be removed for instance to change the overall size of the Venetian blind or for repair or replacement of individual slats. It is hence also easy according to the invention to change the overall appearance, for instance colour, of the Venetian blinds to meet changing requirements. These and other objects and advantages are attained by the Venetian blind according to the invention. It is understood that although the various elements of the Venetian blind according to the invention here are described and shown as used to form one specific Venetian blind it is also possible to use one or more of the elements (for instance the bottom portions, the lift mechanism etc.) separately, for instance in connection with other devices.

### TECHNICAL FIELD

The present invention relates generally to Venetian blinds and more specifically to a flexible Venetian blind designed such that it can easily be adapted to different window sizes and wherein the individual slats of the Venetian blind can easily be mounted and dismantled for repair, cleaning or change of appearance. The invention furthermore relates to a production method for such slats. Furthermore the invention relates to lift mechanisms for raising and lowering the slats of the Venetian blind.

### BACKGROUND OF THE INVENTION

Presently two types of Venetian blinds are commercially available. Firstly, a Venetian blind may be tailored to the specific application, i.e. the customer provides the manufacturer with the specific dimensions and other pertinent characteristics (types/materials of the slats, specific colours and surface textures of the slats, etc.) and the manufacturer delivers the tailored Venetian blind to the customer, ready for installation. The installation may furthermore be carried out by a skilled person - not by the customer himself. The tailored Venetian blind - and possibly also installation of this - is of course rather expensive, but it does relieve the customer (end user) of the burden of making cumbersome modifications of a standard Venetian blind - modifications that may not always be possible at all - and of the often cumbersome installation of the Venetian blind,

Secondly, a comparatively cheap Venetian blind of standardised dimensions may be purchased, but such Venetian blinds often does not fit the dimensions of window openings etc, well, as a consequence of which the end user often chooses a Venetian blind of smaller dimensions (for instance width) than would have been optimal for the specific purpose.

Accordingly, there is a need for tools and methods that facilitate easy and correct fitting and mounting of Venetian blinds to a large variety of window openings,

U.S. Pat. No. 4,567,930 describes a Venetian blind, the width of which can be adjusted by the end user during installation of the Venetian blind without the application of tools. Specifically the length of the slats can be shortened by the provision of a number of lines of weakness in the slats, whereby the slats can be shortened as required by snapping off the required number of increments. Furthermore, this document describes a length adjustable head rail and bottom rail. The Venetian blind according to this document has lift cords passed through openings in the slats in the traditional manner.

EP 0 491 096 A1 describes a Venetian blind with length adjustable head rail and bottom rail. A corresponding adjustment of the longitudinal extension of the slats is not described in this document. The Venetian blind described in this document also have lift cords passing through openings in the slats,

Tailoring of a Venetian blind in situ requires among others the fitting of the maximum height of the Venetian blind to the particular window opening. Traditionally, a bottom rail is used for determining this height through attachment of the lift and tilt (ladder) cords of the Venetian blind to the bottom rail.

The traditional bottom rail cannot be constructed as light and thin as the slats of the Venetian blind and for aesthetic reasons it would be desirable to provide an alternative to the traditional bottom rail that would be less conspicuous than the traditional bottom rail and that would also make adjustment of the Venetian blind considerably easier.

Traditionally, Venetian blinds are provided with slats made of a plastic material, wood or aluminium. In the latter case, roll forming is normally used for giving the slats a slight curvature in order to make the slats more rigid. Plastic slats can for instance be made by extrusion.

The slats of a Venetian blind can alternatively be made of cardboard or carton and for such slats it would be advantageous also to apply one of the processing techniques mentioned above for providing carton or cardboard slats having the slight curvature known from slats made of plastic material, wood or aluminium,

A substantial number of lift mechanisms for Venetian blinds are known within the art. Many of these mechanisms are designed for Venetian blinds, where the raising and lowering of the slats of the Venetian blind are accomplished with a number of single lift cords passed from the mechanism mounted in the head rail of the Venetian blind and through openings in the individual slats to the bottom rail of the Venetian blind,

Furthermore, a number of Venetian blinds applying pairs of lift cords are known within the art. This solution has among others the advantage that the lift cords do not have to be passed through openings provided in the individual slats, and hence the individual slats can be left without through openings, which is advantageous from the point of view of blocking light passage through the Venetian blind. Another major advantage is obtained with this lift system in that the individual slats can be removed from the Venetian blind without the necessity of dismantling the whole Venetian blind. This is of considerable importance both in case of replacement of individual slats in case of damage to these and when slats have to be cleaned.

In some known lift mechanisms for pairs of lift cords, the two lift cords of each given pair are both wound helically on a single drum. However, this solution can be problematic as the two separate lift cords of a given pair of lift cords may get entangled, especially when the lift mechanism is used in Venetian blinds comprising very lightweight slats. It is hence desirable to provide an improved and yet simple lift mechanism for a Venetian blind comprising lightweight slats, which mechanism offers a reliable operation without the risk of the lift cords becoming entangled.

### SUMMARY OF THE INVENTION

On the above background it is an overall object of the invention to provide a very flexible Venetian blind that easily can be adapted to various sizes of for instance window openings, by a person having limited skill in mounting and adapting Venetian blinds. Also the Venetian blind according to the invention is designed such that individual slats can easily be removed for instance to change the overall size of the Venetian blind or for repair or replacement of individual slats. It is hence also easy according to the invention to change the overall appearance, for instance colour, of the Venetian blinds to meet changing requirements. These and other objects and advantages are attained by the Venetian blind according to the invention. It is understood that although the various elements of the Venetian blind according to the invention here are described and shown as used to form one specific Venetian blind it is also possible to use one or more of the elements (far instance the bottom portions, the lift mechanism etc.) separately, for instance in connection with other devices.

On the above background it is an object of the present invention to provide a top profile or head rail for a Venetian blind that is easy to adapt to different window openings without the application of tools.

According to the invention, this objective is obtained with the provision of a top profile that has a telescopic adjustment area that allows the user to adjust the width without the needs of tools.

According to a first embodiment of the invention, this is achieved with a telescopic function comprising a turnbuckle portion of top profile where the two end parts move when the mid section is turned. Other embodiments where the different parts of the top profile are pulled/pushed relative to each other in a telescopic manner are also possible within the scope of the present invention.

According to a second embodiment of the invention, the objective is obtained with a top profile or head rail designed in a manner substantially corresponding to an expandable shower curtain rod. Such an arrangement can for instance comprise a tubular (or generally hollow) middle section into either longitudinal ends of which there are passed expansion portions that inside the middle section are urged in opposite longitudinal directions by an appropriate compression spring arrangement. A very simple arrangement would consist of one compression spring being inside the middle section provided between proximate end faces of the two extension portions or alternatively a transverse wall could be provided, subdividing the inside of the middle section in two longitudinal chambers, one for accommodating one of the extension portions and the other for accommodating the other extension portion. A compression spring could be provided between the proximal end face on one of the extension portions and said transverse wall, and a second compression spring could be provided between the proximal end face of the other extension portion and the transverse wall. In order to ascertain symmetrical extension of the extension portions longitudinally relative to the middle section, the extension portions could for instance be provided with a high pitch thread in operative engagement with mating means provided on the inner surface of the middle section.

The profile according to the invention can be hung for example in a window using brackets provided in the upper horizontal portion of the window opening. Alternatively, the expandable top profile could be fastened to either vertical side face of the window opening either by engagement between means provided at the longitudinal end faces of the top profile and mating brackets provided on the side faces of the window opening or simply by friction between the end faces of the top profile and the corresponding parts of the vertical side faces of the window opening. A magnetic attachment between the mounting brackets provided on the vertical side faces of the window opening and the end faces of the top profile would also be an alternative. A person skilled in the art would be able to devise other alternatives that would also fall within the scope of the present invention.

According to a specific embodiment, the top profile may be used as a measurement ruler, thereby providing an easy means of measuring the distance between opposing surfaces of for instance a window opening. To this effect a scale could for instance be provided on one of the extension portions, and the scale could for instance be read through a window in the middle section or otherwise.

It is understood that the above means of mounting the top profile in for instance a window opening can be used for both embodiments of the invention described above.

According to a first aspect of the invention, there is provided a top profile (head rail) for a Venetian blind comprising a telescopic middle section consisting of a main body into which at either longitudinal end an extension body is inserted for telescopic movement relative to said main body, whereby the total longitudinal extension of the top profile can be varied.

According to an embodiment of the invention, end portions are provided at either longitudinal end of the top profile in fixed relationship to a respective adjacent extension body.

According to a preferred embodiment of the invention, the main body and the extension bodies of the middle section are tubular members and the extension bodies are in threaded engagement with the main body such that a rotation of said main body relative to said extension bodies results in a variation of the total length of the top profile.

According to a second aspect of the invention, there is provided a Venetian blind comprising a top profile (head rail) according to the invention as described above, the Venetian blind comprising a plurality of slats connected via ladder (tilt) and lifting cords to corresponding tilt and lift mechanisms provided in the top profile, wherein the distance from one distal end of said slats to the nearest pair of ladder and lifting cords is kept constant.

According to an embodiment of the invention, the individual slats are connected to or provided on the ladder cords in a notch provided in each individual slat at the distance L1 from the end of the slat

On the above background, it is a further object of the present invention to provide a top profile as an alternative to the traditional bottom rail for a Venetian blind that is less conspicuous than the traditional bottom rail and that would also make adjustment of the Venetian blind considerably easier.

The above and other objects are obtained with an adjustment and fixing bracket according to the invention.

The inventive idea is to ease the height configuration of a Venetian blind, by using a weight bracket instead of the traditional bottom rail. This will lighten the general appearance of the blind and make it significantly easier to adjust.

The weight bracket is according to the invention mounted on the ladder cord and the lift cord, in the preferred height, by a small click bracket. The weight parts are mounted under the slat where the ladder and lift cords are placed and then the slat and weight parts are placed on top of the plastic bracket.

For giving the bracket a visual refinement and to hold the parts together, a cover can be added to the bracket.

According to a first aspect of the invention, there is thus provided an adjustment and fixing bracket for a Venetian blind comprising a bracket portion formed for releasable attachment to ladder cords (tilt cords) or lift cords or both ladder and lift cords of a Venetian blind, and a weight body, the bracket portion being provided with means for releasable attachment of said weight body to said bracket portion.

According to an embodiment of the invention, the bracket portion comprises a central portion, at either longitudinal ends of which there is provided an end portion, pivotably connected to the respective end of said central portion via respective hinge portions.

According to an embodiment of the invention, the central portion is provided with resilient engagement means for releasable attachment of said weight body to the bracket portion.

According to an embodiment of the invention, there is furthermore provided a cover part of such a shape that said bracket portion and said weight body can be releasably covered by the cover part.

According to a second aspect of the invention, there is provided a Venetian blind comprising ladder (tilt) cords and lift cords and an adjustment and fixing bracket as described above for mounting beneath the lowermost slat of the Venetian blind.

According to a third aspect of the invention there is provided a method of adjusting and fixing the slats of a Venetian blind comprising the following steps:

(a) providing pairs of ladder (tilt) cords and lift cords extending downwards from a top profile (head rail) of a Venetian blind;

(b) at the desired distance below said top profile (head rail) providing a releasable bracket portion on said cords;

(c) releasably fixing said bracket portion to said cords at said distance below the top profile (head rail);

(d) releasably providing a weight body on said bracket portion.

As final steps in the above method, said cover part may be provided over the adjustment and fixing bracket for protective and decorative reasons and the remaining lengths of the ladder and lift cords can be cut off immediately below the adjustment and fixing bracket.

The present invention relates to tools and methods for easy and correct mounting of Venetian blinds in window openings of different size.

According to a first aspect of the invention there is provided an adjustable measurement and fitting template by means of which the longitudinal extension of the head rail or top profile and the slats of a Venetian blind can be determined.

According to a second aspect of the invention there is provided a method for easy and correct fitting and mounting of a Venetian blind in window openings of different sizes.

According to the invention there is provided an adjustable measurement and fitting template comprising a telescopic arrangement by means of which the longitudinal extension of the template can be varied. The template comprises a telescopic middle section, the longitudinal extension of which can be varied. The template comprises furthermore distal end portions, each of which being provided with a stop bracket, the width of which is equal to the free space needed between the Venetian blind and the surroundings. Advantageously, the template is provided with means for locking it in the finally adjusted length of the template, so that the length of the template does not change during use hereof. Furthermore, the template can advantageously be provided with through holes to determine the proper position of screw holes to be cut in the upper window portion for mounting brackets for the top profile (head rail) of the Venetian blind.

It is a still further object of the present invention to provide a method for producing carton or cardboard slats for a Venetian blind, where the slats have a slight curvature that among others will increase the rigidity of the slats.

According to the invention, carton or cardboard is produced in “endless” rolls of flat sheet material, and the carton or cardboard sheets are then provided to a roll-forming machine that heats up the carton or cardboard sheet and creates a curved profile with enough flexibility to allow the curved profile to be wound up on coils without the profile losing its curvature.

In the detailed description of the invention, reference is made to a specific commercially available paperboard product that can be used to form slats for a Venetian blind using the method of the invention, but other paperboard or cardboard materials may also be used in a roll-forming method,

The present invention relates to the use of roll forming techniques for forming curved sheets of paperboard, carton or cardboard,

The present invention relates furthermore to a method for producing slats for Venetian blinds, where said slats are made of a paperboard, carton or cardboard material, the method comprising the following steps:

(i) providing one or more sheets of paperboard, carton or cardboard material of substantially planar cross section (2) to a roll-forming machine (3), whereby said one or more sheets of paperboard, carton or cardboard material is/are provided with a fixed curved cross section (4);

(ii) cutting (6) said sheets into the appropriate length for forming a slat (10) for a Venetian blind,

The above objective is according to the present invention attained by the provision of a separate winding drum (which can be for instance of a cylindrical or conical shape) for each lift cord of a given pair of lift cords,

According to a first specific embodiment, the above principle of the invention is implemented as a double cone (or drum) lift mechanism comprising a central portion containing guide means for the lift cords directing the two lift cords of a given pair of lift cords from the circumferential surface of said cone or drum downwards towards the slats and/or bottom rail of the Venetian blind. According to one specific embodiment, a central portion of the mechanism also comprises the tilt mechanism for the Venetian blind.

According to still another embodiment, one or more tilt mechanisms may alternatively be provided separately from the lift mechanism,

According to another specific embodiment, the principle of the invention is implemented by separate winding drums placed alongside each other, i.e. with individual longitudinal axes extending substantially in parallel with each other.

Other arrangements of the separate winding drums may, however, also be provided without departing from the scope of the invention.

According to said first embodiment, longitudinally on either side of said central portion the two lifting cone or drum portions are extending, one for each of the lift cords of the given pair of lift cords. When these cone or drum portions are rotated, for instance by a drive shaft extending through and in engagement with the cone or drum portions, the respective lift cords of the pair of lift cords become helically wound on or off the respective cone or drum portions.

According to a preferred embodiment of the mechanism according to the present invention, at least a part of the outer circumferential surface of the cone or drum portions is covered by a cover part, preferably of such a curvature that a uniform gap is created between the outer circumferential surface of the respective cone or drum portion and the adjacent surface of the cover, such that the lift cord when wound on the cone or drum portion is confined within this gap, thereby preventing entanglement of the helical windings of the lift cord on the surface of the cone or drum portion. The width of this gap can either be somewhat greater than or equal to the diameter of the lift cords. It is, however, also possible to use a width of the gap somewhat less than the cord diameter, which will have the beneficial effect of forcing the lift cord out of the winding mechanism, such that a reliable operation of the winding mechanism can be ascertained for instance when very lightweight slats are used in the Venetian blind.

According to the invention, there is thus provided a lift mechanism for a Venetian blind, where the Venetian blind comprises pairs of lift cords for raising or lowering the slats of the Venetian blind, the lift mechanism comprising two cone or drum portions, upon an outer circumferential surface of one of these portions one lift cord of a given pair of lift cords is wound upon rotation in a first direction of the drum portion and from which the lift cord is unwound upon rotation in an opposite second direction of the drum portion, and upon an outer circumferential surface of the other cone or drum portion, the other lift cord of a given pair of lift cords is wound upon rotation in said first direction of this other drum portion and from which the lift cord is unwound upon rotation in said opposite second direction of this drum portion.

According to a specific embodiment of the invention, the lift cords pass through lift cord guide channels extending substantially tangentially to the corresponding outer circumferential surface of each respective cone or drum portion.

According to a preferred embodiment, the two cone or drum portions are provided coaxially with each other. They can furthermore be connected through a central connection, such that they rotate with each other. This central connection may furthermore comprise a tilt mechanism for the slats of the Venetian blind.

In addition to the lift mechanism as such, the present invention also relates to the winding drums used for winding the lift cords of the Venetian blind. Such winding drums can comprise either one or more outer circumferential surface portions, upon which the lift cord is wound and the cross sections of these one or more winding portions of the total winding drum can according to various embodiments of the present invention assume different shapes.

Thus, according to one embodiment of a lift mechanism according to the present invention, cone or drum winding portions of the mechanism comprise a first drum portion upon which the lift cord is wound or from which it is unwound and a second drum portion extending longitudinally from the first drum portion, to which second drum portion the lift cord is attached, wherein the first drum portion is substantially cylindrical or conical and where the cross sectional shape of the second portion is such that the circumference of the cross section of the second portion is less than the circumference of the first drum portion.

According to one embodiment, the second drum portion has a cross section, whose boundary is piecewise linear.

According to another embodiment, the boundary of the cross section of the second drum portion comprises curved portions,

According to a specific embodiment, the cross sectional shape of the second drum portion is hexagonal, triangular, square or formed as an asterisk.

According to still another specific embodiment, the cross section of the second drum portion is circular over one or more angular sections θᵢ and non-circular over one or more other angular sections φⱼ.

The maximum radial extension of the first and second drum portions may be equal to each other, but it would also be possible to provide first and second portions with different maximum radial extension without departing from the scope of the invention.

Although the present specification focuses on a dual drum mechanism for winding two lift cords in a Venetian blind, it is understood that a single drum according to the invention can be used alone, for instance in Venetian blinds comprising a number of single lift cords passed through apertures in the slats between a head rail containing the winding mechanisms and either the lowermost slat or a bottom rail of the Venetian blind.

It is to be noted that although the different elements (head rail, bottom brackets etc.) and the fitting and production method have been described as comprising a unity, i.e. that they are all applied in or for a specific Venetian blind, the individual elements and methods described above and in the following detailed description of the invention can also be used separately in connection with for instance other types of Venetian blinds.

### BRIEF DESCRIPTION OF THE DRAWINGS

The present invention will be better understood with reference to the following detailed description of an embodiment of the invention and with reference to the figures, where

FIG. 1 illustrates by means of an example a lower portion of a Venetian blind showing an embodiment of the adjustment and fixing bracket according to the invention;

FIGS. 2(a) through (e) illustrate a sequence of steps performed during mounting of an embodiment of an adjustment and fixing bracket according to the invention; and

FIGS. 3(a) through (c) illustrate the final sequence of steps performed during mounting of the embodiment of the adjustment and fixing bracket according to the invention shown in FIG. 2, and (d) illustrates a bottom portion of a Venetian blind after assemblage using the adjustment and fixing bracket according to the invention.

FIG. 4 shows a schematic perspective view of an embodiment of the lift mechanism according to the invention;

FIG. 5 shows an exploded view of the embodiment of the invention shown in FIG. 4;

FIG. 6(a) shows a plane side view of the embodiment of FIG. 4;

FIG. 6(b) shows a cross-sectional view along section A-A as indicated in FIG. 6(a);

FIG. 6(c) shows a plane view of the embodiment of FIGS. 4 and 6(a) seen from one longitudinal end;

FIG. 7 shows the embodiment of FIGS. 4 and 6(a) seen from below along section B B as indicated in FIG. 4(a);

FIG. 8 shows the embodiment of FIGS. 4 and 6(a) seen from above;

FIG. 9 shows a cross sectional view through the embodiment of FIG. 8 along the section C-C as indicated in FIG. 5;

FIGS. 10(a) through 10(i) show different embodiments of a winding drum according to the invention; and

FIG. 11 shows an alternative embodiment of the invention comprising a pair of winding drums placed parallel to each other and driven by a common drive motor.

FIG. 12 shows a schematic representation of a top profile or head rail according to an embodiment of the invention together with slats and lift and tilt cords of a Venetian blind comprising the inventive top profile.

FIG. 13 shows a schematic representation of an embodiment of an adjustable measurement and fitting template according to the invention;

FIGS. 14(A), (B) and (C) show initial steps of the method according to the invention for fitting a Venetian blind to a specific window opening;

FIGS. 15(A) and (B) show further steps of the method according to the invention; and

FIGS. 16(A) and (B) show final steps in the method according to the invention and FIG. 14(C) shows details of an adjustment of a fixing bracket used according to the invention as an advantageous alternative to a traditional bottom rail.

FIG. 17 shows a schematic representation of an embodiment of the method for cardboard slat production according to the invention.

### DETAILED DESCRIPTION OF THE INVENTION

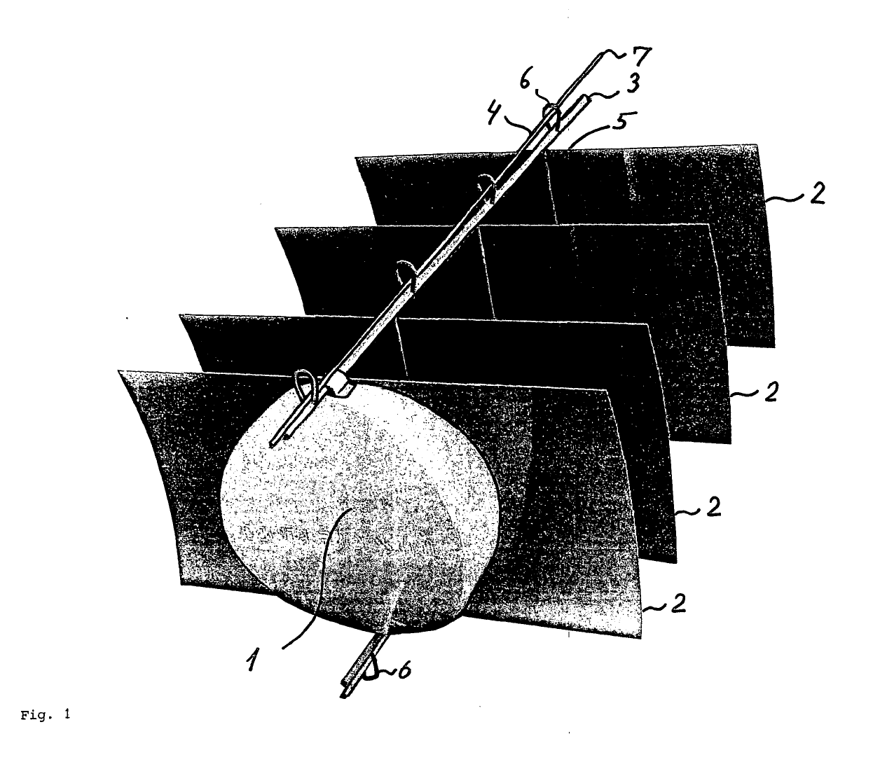

With reference to FIG. 1 there is shown an exemplifying illustration of a lower portion of a Venetian blind showing an embodiment of the adjustment and fixing bracket according to the invention. The adjustment and fixing bracket is placed beneath the lowermost of the slats 2 of the Venetian blind, but only a cover 1 is visible in FIG. 1. The tilt (ladder) cords 3, comprising ladders 5 and the lift cords 7 are shown in FIG. 1, and the lift cords 7 are in this embodiment passed through loops 6 provided on the ladder cords. In order to position and maintain the individual slats 2 in their correct position relative to the ladder and lift cords, the individual slats can be provided with a small indentation or notch in the longitudinally extending edge portion of the slat, i.e. for instance at the position indicated by reference numeral 17 in FIG. 1. The details of this indentation or notch are not shown in the figures.

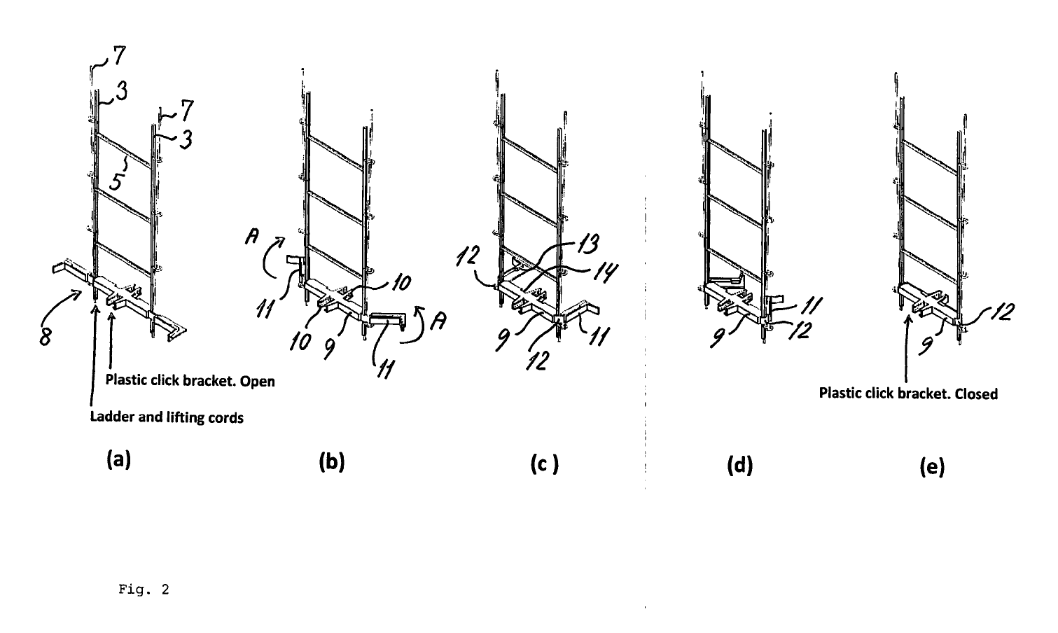

With reference to FIG. 2(a) through (e) there is shown an illustrative sequence of steps performed during mounting of an embodiment of an adjustment and fixing bracket according to the invention at the appropriate location on the ladder and lift cords.

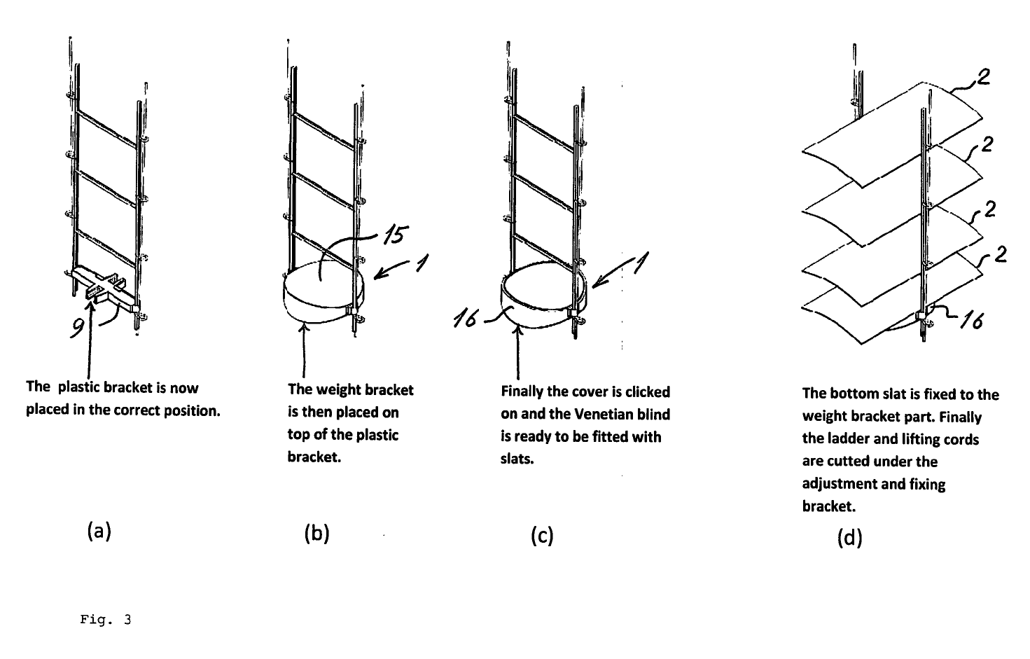

The adjustment and fixing bracket according to the invention comprises the bracket portion generally designated by 8 in FIG. 2(a), a weight body 15 (FIG. 3(b)) and an optional cover part 16 (FIG. 3(c)). As shown in FIG. 3(b), the bracket portion 8 comprises a central portion 9 resilient engagement means 10 for releasable attachment of the weight body 15 to the bracket portion. At either end of the central portion 9 there is provided end portions 11, connected to the central portion 9 via hinge portions 12, such that the end portions 11 can be swung relative to the central portion 9 around the ladder and lift cords 3, 7 as illustrated by the arrows A. The end portions 11 are provided with releasable engagement means 13, such that the end portions in the final mounting step can be click locked to the central portion 9, whereby the bracket becomes fixed to the ladder and lift cords. This state is shown in FIGS. 2(e) and 3(a),

FIGS. 3(a) through (c) illustrate the final sequence of steps performed during mounting of the embodiment of the adjustment and fixing bracket according to the invention shown in FIG. 2. When the bracket portion 8 is fixed in its proper position on the ladder and lift cords as shown in FIG. 3(a), the weight body 15 is attached to the bracket portion 8 by means of the resilient engagement means 10 and mating elements provided on the weight body 15. As shown in FIG. 3(c), a cover that may serve protective as well as decorative purposes can finally be provided over the weight body. Finally, the ladder and lift cords can be cut off under the adjustment and fixing bracket thereby providing an aesthetically pleasing appearance of the finished Venetian blind.

It is understood that the embodiment of the adjustment and fixing bracket described above can be designed in various alternative manners without thereby departing from the scope of the invention. Thus, for instance the shape and size of the weight body may be varied for instance corresponding to different designs of the slats of the Venetian blind and also the releasable bracket portion may be designed in different manners maintaining its ability to easily being provided on, fixed to and, if necessary removed from the ladder and lift cords.

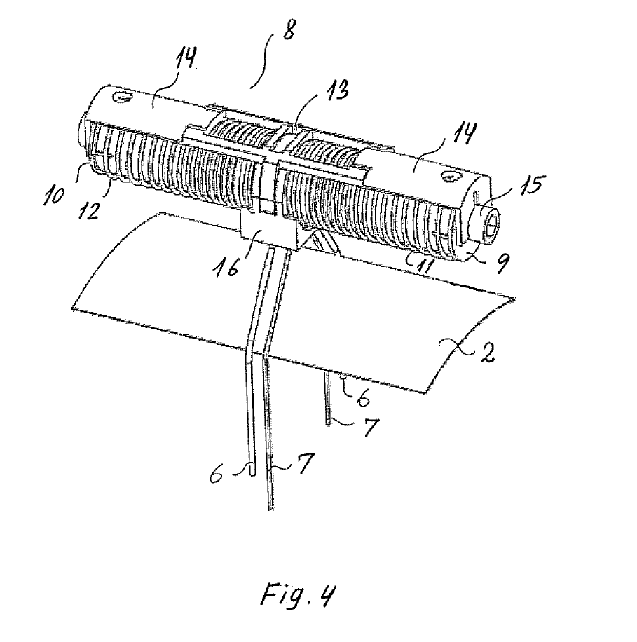

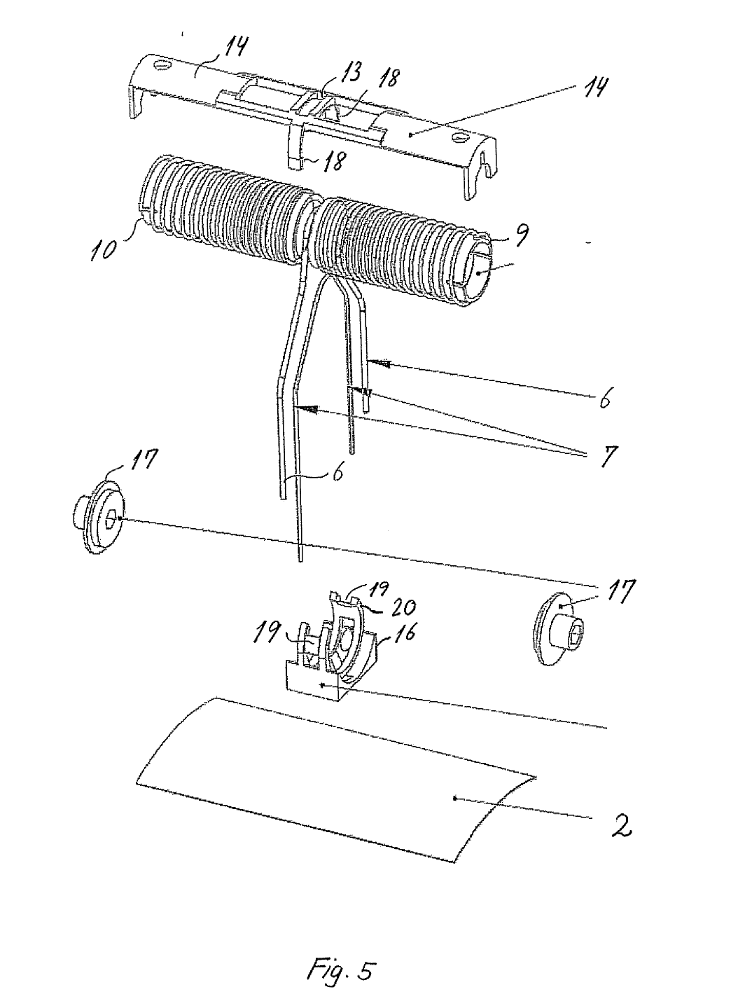

With reference to FIG. 4 there is shown show a schematic perspective view of an embodiment of the lift mechanism according to the invention. The mechanism is generally designated by reference numeral 8 and comprises two cylindrical cone or drum portions 9 and 10 longitudinally provided to the right and left (as seen in FIG. 5) of a central portion that comprises a guide bracket 16 for the cone or drum portions and a track 13 for accommodating the tilt cords 6 of the Venetian blind. The cone or drum portions 9, 10 are provided with end caps 15 at either longitudinal end of the mechanism 8. Extending above (as seen on FIG. 4) portions of the cone or drum portions 9, 10, a cover 14 is provided, the curvature of which substantially corresponds to that of the cone or drum portions such that a gap of substantially uniform width in the radial direction is created between the outer circumferential surface of those portions of the cone or drum portions that are covered by the cover 14. The radial width of this gap corresponds substantially to the diameter of the lift cords 7 so that the lift cords, when wound on the cone or drum portions 9, 10, are prevented from being entangled. It is, as mentioned above, also possible to use a radial width of the gap somewhat less than the cord diameter, which will have the beneficial effect of forcing the lift cord out of the winding mechanism, such that a reliable operation of the winding mechanism can be ascertained for instance when very lightweight slats are used in the Venetian blind.

The lift cords 7 are wound helically on/off the cone or drum portions 9, 10 as indicated by 11 and 12, respectively. Towards the end of the cone or drum portions 9, 10 facing the central portion 4, 13, there is provided guide means, for instance formed as channels 21, 22 (see FIG. 4), leading the lift cords 7 and the tilt cords 6 towards the slats 2 of the Venetian blind.

The cone or drum portions 9 and 10 are connected in the central part of the mechanism and are brought to rotate together by suitable drive means (not shown in the figures) that can either be provided separately for each separate mechanism 8 or provided as a common drive means for two or more of such mechanisms.

The details of the mechanism 8 are more clearly visible in the exploded view of the embodiment of the invention shown in FIG. 5. The upper cover part 14 is when the mechanism 8 is assembled, snap-fitted to the guide bracket 16 by engagement of radially resilient tongues 18 on the cover part and mating retaining means 19 on the guide bracket 16.

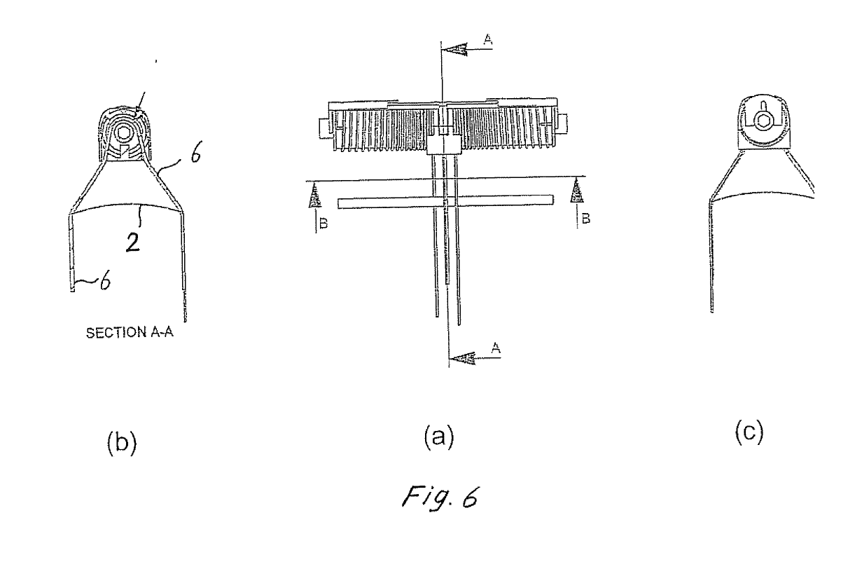

With reference to FIG. 6(a), there is shown a plane side view of the embodiment of FIG. 4. FIG. 6(b) is a cross sectional view along section A-A as indicated in FIG. 6(a) showing the provision of the tilt cord 6 around the middle section connecting the two cone or drum portions 9, 10 with each other, FIG. 6(c) further shows a plane view of the embodiment of FIGS. 4 and 6(a) seen from one longitudinal end hereof.

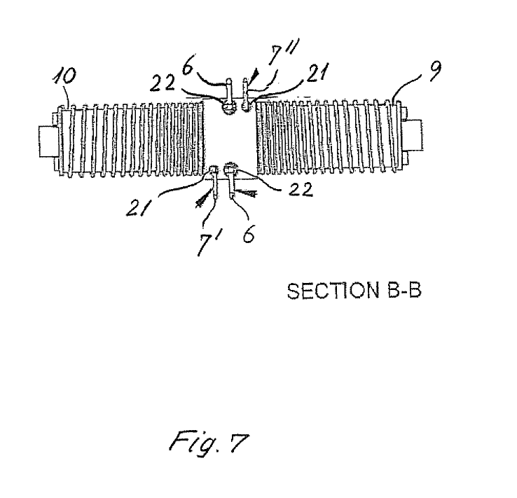

With reference to FIG. 7, there is shown the embodiment of FIGS. 4 and 6(a) seen from below, i.e., from the slats of the Venetian blind, along section B-B as indicated in FIG. 6(a). As indicated in FIG. 7, the lift cords 7′ enter from below through a lift cord guide channel 21 and wind around the cone or drum portion 10, thereby creating a left spiral and the lift cords 7″ enter from below through another lift cord guide channel 21 and wind around the cone or drum portion 9, thereby creating a right spiral. The tilting cords 6 enter the central section through tilt cord guide channels 22 and run in a V-shaped track between the two cone or drum portions 9, 10.

Although the entrances of the two lift cord guide channels 21 in FIG. 7 are shown longitudinally displaced relative to each other and longitudinally symmetrically on either side of the entrances of the two tilt cord guide channels 22, it is also possible in another embodiment of the invention to form the lift cord guide channels 21 such that their entrances are located at the same longitudinal position and at the same longitudinal position as the entrances of the tilt cord guide channels. Thereby both lift and tilt cords will be located in a common transversal plane relative to the longitudinal axis of the mechanism and lift and tilt cords can thereby run along each other downwards from the head rail of the Venetian blind.

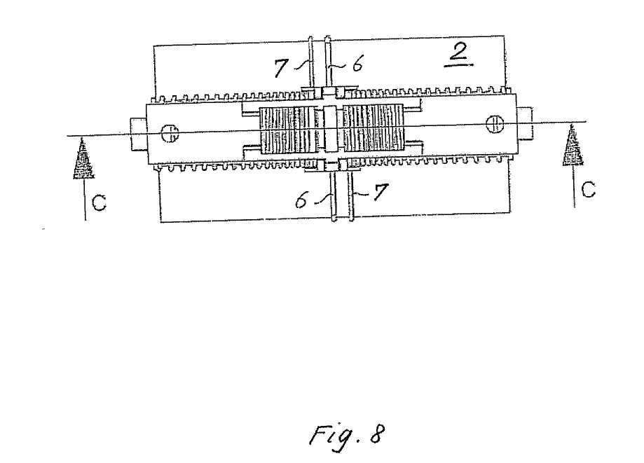

FIG. 8 shows the embodiment of FIGS. 4 and 6(a) seen from above.

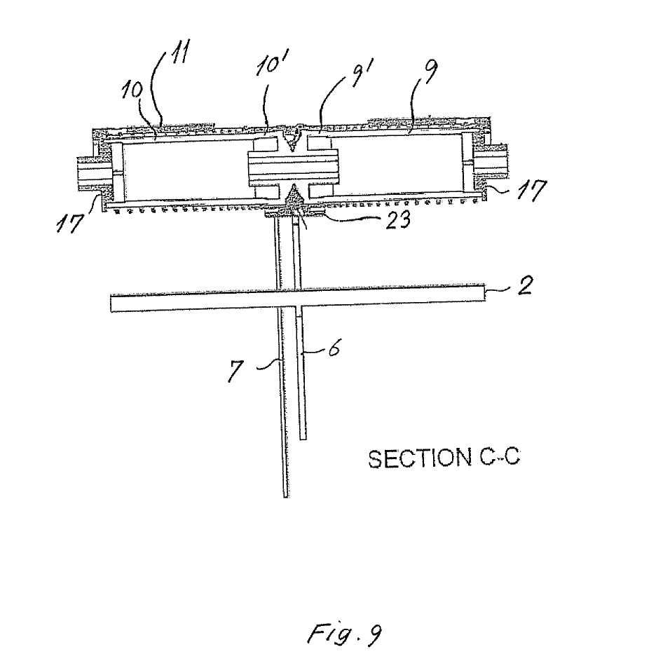

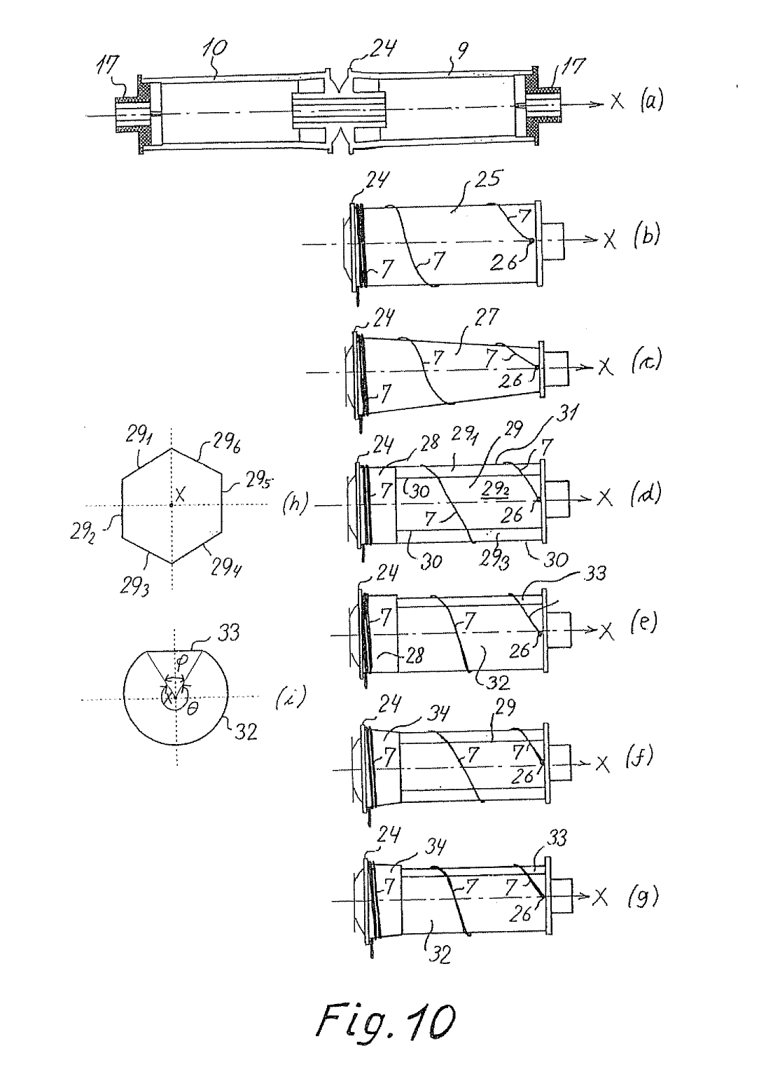

With reference to FIG. 9, there is shown a cross sectional view through the embodiment of FIG. 8 along the section C C as indicated in FIG. 8. As it appears from FIG. 9, the cone or drum portions 9, 10 can according to a specific embodiment each comprise a first cylindrical section 9, 10 and towards the central portion of the mechanism comprise a second section 9′, 10′ with increased diameter, upon which the lift cords 7 wind/unwind upon entering/leaving the guide channels 21 provided in the central guide bracket 16. The sections 9′, 10′ can be conical sections widening towards the central V-track, but the invention is not limited to conical sections 9′, 10′ and other geometries may also be used without thereby departing from the scope of the invention, A non-limiting number of such winding drum embodiments according to the present invention are shown with reference to FIGS. 10(a) through 10(g)

FIG. 10(a) shows an embodiment of a dual winding drum identical with that of FIG. 9. In FIG. 10(a) only the dual winding drum (9, 10) itself is shown and the cord 7 and cover 14 have been omitted for clarity. Furthermore, FIGS. 10(b) through 10(g) only show one of the two winding drums in the dual winding mechanism. The turns of the lift cord 7 wound upon the winding drum is schematically indicated in FIGS. 10(b) through 10(g).

FIG. 10(b) shows a purely cylindrical winding drum 25 towards the central portion provided with a shoulder 24 that pushes the turns of the lift cord 7 in the positive direction of the longitudinal axis X, i.e. towards the lift cord fixing point 26, when the lift cord is wound upon the drum. A cylindrical winding drum requires that the friction between the circumferential surface of the drum 25 and the lift cord 7 wound upon the drum be low over a certain longitudinal portion of the drum surface extending from the point 26 at which the cord is fixed to the drum and towards the central portion.

Although the embodiments of winding drums according to the invention shown in FIGS. 10(a) through 10(g) are all provided with the shoulder 24, the effect of pushing the turns of the lift cord towards the fixing point 26 could alternatively have been provided by using the end faces 20 of the retaining means 19 on the guide bracket 16 shown in FIG. 5 as abutment means for the lift cord.

FIG. 7(c) shows a purely conical winding drum 27 that does not require the portion of low friction mentioned above for the cylindrical winding drum 25. The inclination angle of the cone must, however, be chosen within a proper interval dependent among others on the diameter and surface texture of the lift cord 7. For an inclination angle below this interval, the conical winding drum 27 approaches a cylindrical drum 25 and hence the requirement stated above will apply, whereas for an inclination angle above the said interval, the cord windings will tend to overlap each other upon winding of the cord on the drum, when the cord windings are pushed towards the cord fixing point 26, whereby the wound cord will easily become entangled, thus preventing proper operation of the lift mechanism.

Although able to function, given the above mentioned requirements are fulfilled, the above two embodiments of winding drums according to the invention may suffer from the problems described above if the requirements relating to surface smoothness and inclination angle as set forth above are not fulfilled. Such potential problems will be solved by the embodiments of winding drums according to the invention illustrated in FIGS. 10(d) through 10(g),

FIG. 10(d) shows an embodiment of a winding drum according to the invention comprising a first substantially cylindrical portion 28 followed by a portion 29 of a hexagonal cross section comprising the surface sections 29₁, 29₂, . . . 29₆. The lift cord 7 is attached to the end of the hexagonal drum portion at the cord fixing point 26. Although this embodiment specifically comprises a hexagonal portion, this portion could alternatively exhibit other cross sectional shapes such as square, triangular etc. The edge portions 30 located at the greatest distance from the longitudinal axis X of the winding drum could extend at a distance from the longitudinal axis X equal to the radius of the cylindrical portion 28, but it would also be possible to deviate from this dimension within certain limits, determined among others by the cord diameter. Furthermore, the said edge portions 30 may for instance be slightly rounded to reduce the risk of wear of the lift cord 7 passing over these edges 30.

FIG. 10(e) shows an alternative embodiment to the one shown in FIG. 10(d), wherein the hexagonal portion is replaced by a cylindrical portion 32, in the circumferential surface of which there has been provided a planar longitudinally extending region 33, the surface of which is closer to the longitudinal axis X than corresponding to the radius of the first cylindrical portion 28.

FIGS. 10(f) and 10(g), respectively, show two embodiments corresponding to those of FIGS. 10(d) and 10(e) but with a conical first drum portion 34 instead of the cylindrical first drum portions 28 shown in FIGS. 10(d) and 10(e).

FIGS. 10(b) and (i) show schematically cross sectional views through the non-cylindrical portions of the winding drum in order to more clearly illustrate the cross sectional shape of these embodiments.

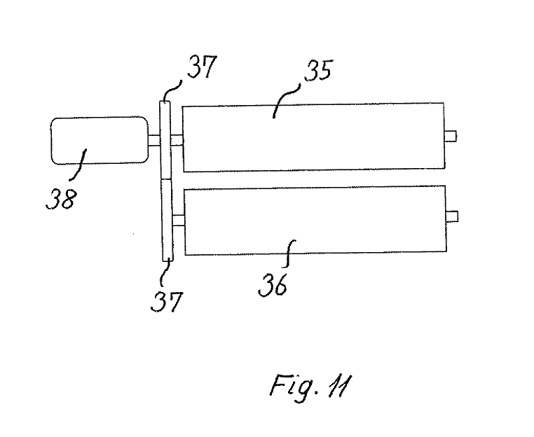

Referring to FIG. 11, there is schematically indicated an alternative embodiment of the invention (seen from above) comprising a pair of winding drums 35, 36 (here cylindrical drums are chosen, but any other embodiment of winding drums according to the invention could also have been used) placed parallel to each other and driven via meshing gear wheels 37 by a common drive motor 38. Two separate drive motors could also have been used as an alternative. Using this configuration, the two lift cords of a given pair of lift cords can easily be located at the same longitudinal position along the slats.

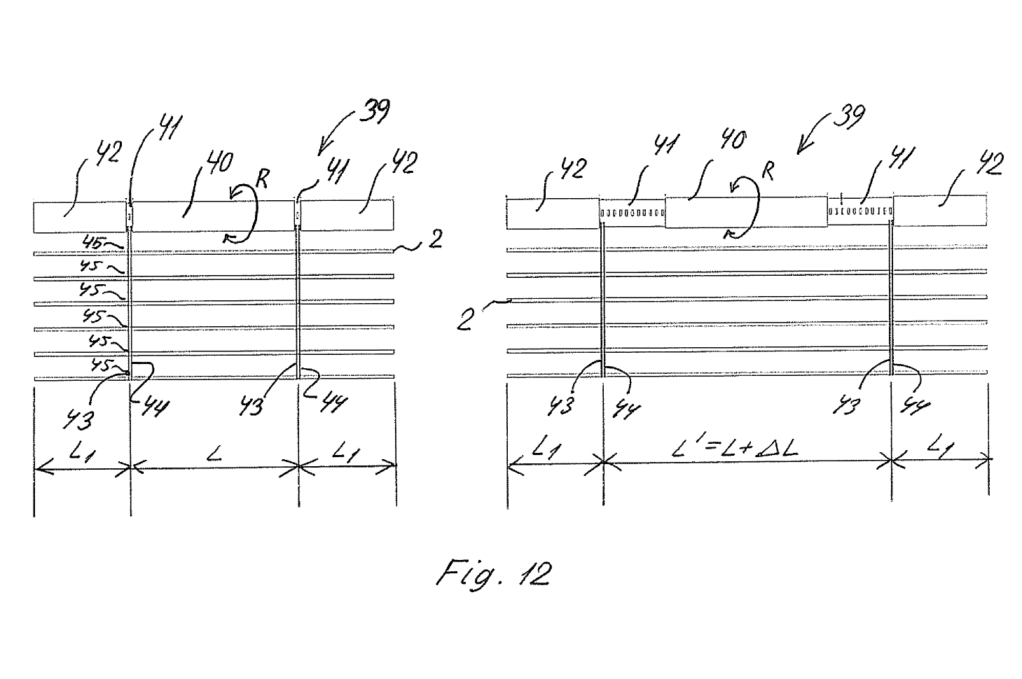

With reference to FIG. 12 there is shown an embodiment of a telescopic top profile according to the invention, the length of which can be varied, for instance from a length of 600 mm to 800 mm for adaptation to a specific window opening.

The top profile is generally designated by reference numeral 39 and consists according to this embodiment basically of a number of tubular bodies that are assembled into a telescopic configuration. Thus, the top profile 39 comprises a central portion 40 that is in threaded engagement with extension portions 41 provided longitudinally at either side of the central portion 40, such that a rotation (indicated by the arrow R) of the central portion 40 about the longitudinal axis through the top profile 39 results in the shown variation of the total longitudinal extension of the top profile, in this example between 600 mm and 800 mm. Oppositely oriented threads are provided on the two extension portions so that rotation of the central portion 40 in one rotational direction will result in the two extension portions 41 moving longitudinally away from each other (thereby increasing the total length of the top profile) and rotation in the other rotational direction will result in the two extension portions 41 moving against each other (thereby reducing the total length of the top profile). At the distal ends of the extension portions 41, end portions 42 are provided in fixed relationship to the respective portions 41.

Ladder (tilt) cords 43 and lifting cords 44 connect the slats 2 of the Venetian blind with respective tilt and lift mechanisms provided inside the top profile. According to an embodiment of the invention the slats 2 of the Venetian blind are provided with a notch 45 at the distance L1 from one end of the slat 2 for fixing the distance L1 between the end of the slats and the attachment of the slats to ladder cords and passage of the lifting cords past the longitudinal edges of the slats. It is an important feature of the present invention that the ladder and lifting cords 43, 44 always remain at the same distance from the end of the respective slats. Only the middle section 40, 41 changes, allowing for the notch 45 provided on the slats 2 to remain at the same position relative to said end of the slats. The notches 45 provided in the slats 2 are only provided at one position (in the figure in the left part of the Venetian blind, although they could alternatively have been provided at a corresponding position on the right part of the Venetian blind) at a given distance L1 from the end of the slats. By this design, the slats can be produced to fit the large variations ΔL of the length of the top profile corresponding to the extension of a given window opening. The slats can then be cut to their final length on site.

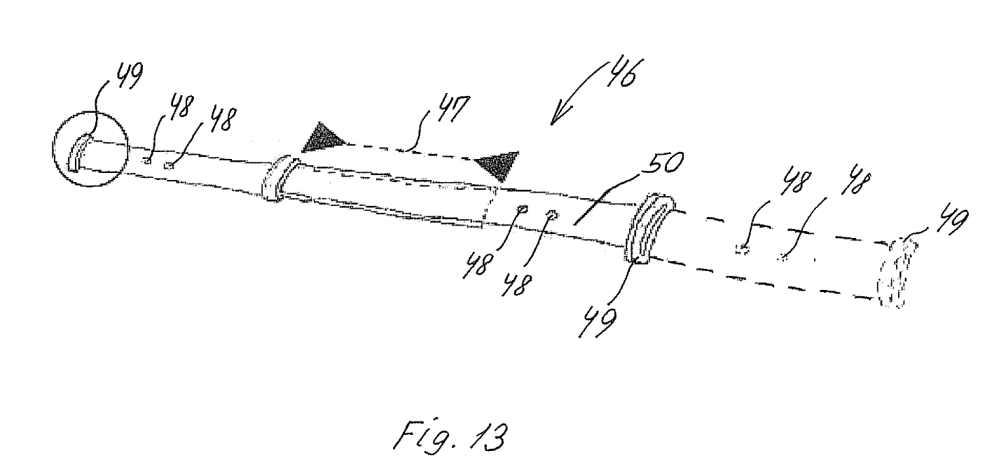

With reference to FIG. 13 there is shown an embodiment of an adjustable measurement and fitting template for a Venetian blind according to the invention. The shown embodiment consists of a telescopic arrangement by means of which the longitudinal extension of the template can be varied. The template generally designated by 46 in FIG. 13 comprises a telescopic middle section, the longitudinal extension of which can be varied as indicated by reference numeral 47. The template comprises distal end portions 50, each of which being provided with a stop bracket 49, the width of which is equal to the free space needed between the Venetian blind and the surroundings. Advantageously, the template is provided with means (not shown) for locking it in the finally adjusted length of the template, so that the length of the template does not change during use hereof. Furthermore, the template can advantageously be provided with through holes 48 to determine the proper position of screw holes to be cut in the upper window portion for mounting brackets for the top profile (head rail) of the Venetian blind.

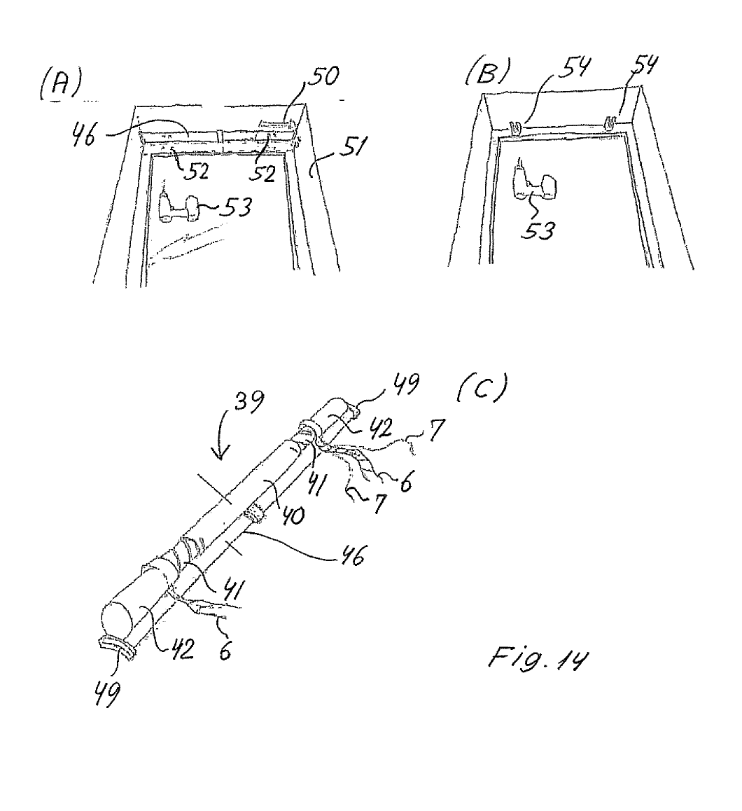

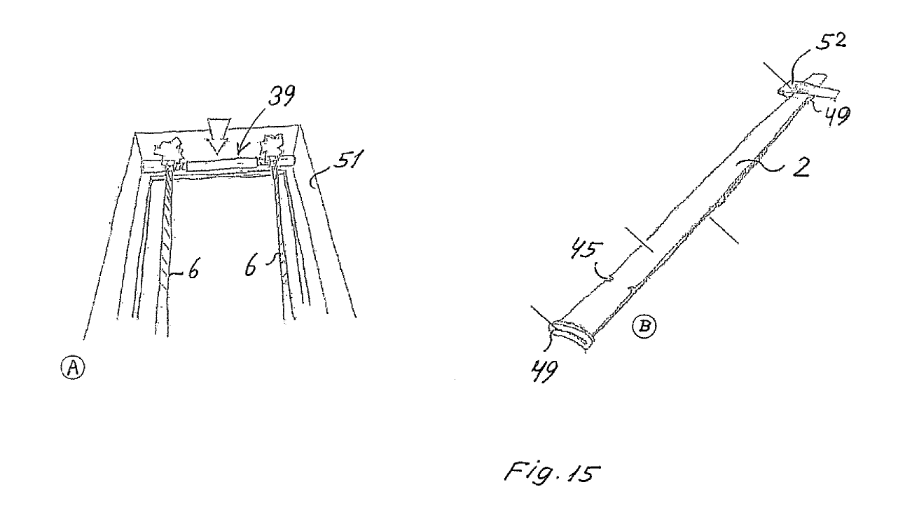

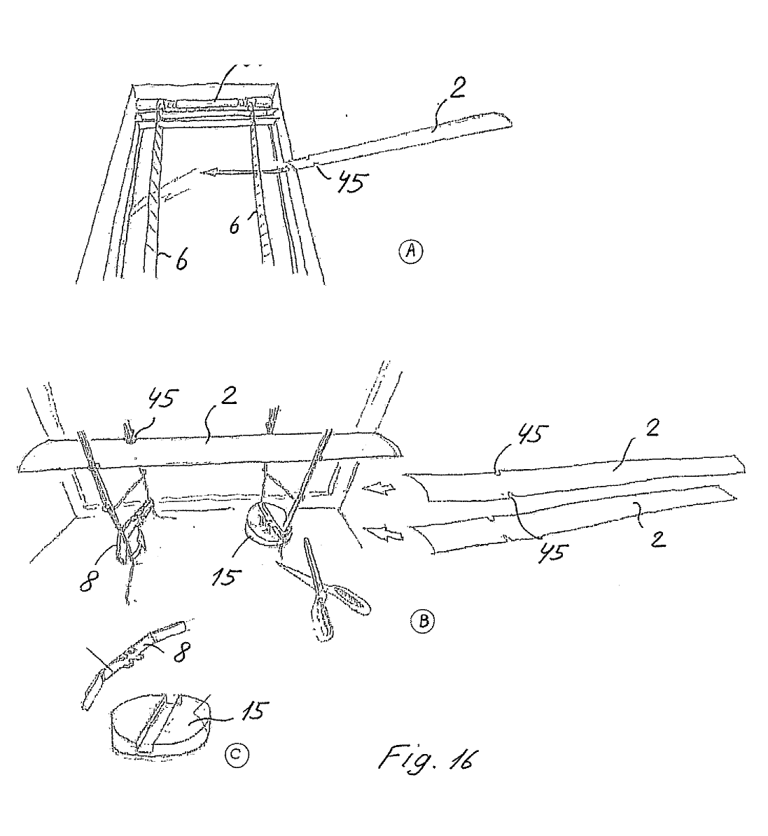

How to use the template according to the invention as shown in FIG. 13 is illustrated in the sequence of pictures shown in FIGS. 14(A), (B) and (C); FIGS. 15(A) and (B); and FIG. 16(A), (B) and (C).

In FIG. 14(A), the template 46 is adjusted to the actual width of a window opening and locked in this adjusted longitudinal extension of the template. The holes for mounting brackets for the top profile of the Venetian blind can be marked through the holes 52 provided in the template. In FIG. 14(B), the brackets 54 for the top profile are being mounted,

With reference to FIG. 14(C) there is shown an adjustable top profile 39 for a Venetian blind. The top profile comprises a telescopic arrangement with a rotatable middle section 40 in threaded engagement with extension portions 41 provided at either longitudinal ends of the middle section, such that a rotation of the middle section will result in a variation of the longitudinal extension of the top profile, whereby the top profile can be adjusted to the width of the specific window opening. The top profile is furthermore provided with end portions 49 in fixed relationship to the extension portions 41. The top profile contains the ladder (tilt) mechanisms and the lift mechanisms of the Venetian blind. Ladder (tilt) cords 6 and lift cords 7 extend from these mechanisms as shown in the figure.

As shown in FIG. 14(C), the template 39 is used for adjusting the correct longitudinal extension of the top profile, by fitting the top profile between the stop brackets 49 on the template.

In FIG. 15(A), the top profile 39 is clicked on the mounting brackets that were mounted as shown in FIG. 14(B), Ladder cords (6) and lift cords (not shown) extend downwards from the top profile.

FIG. 15(B) illustrates the use of the template for adapting a slat 2 to the size of the window opening and the top profile by mounting a cutting means 52 on one of the stop brackets 49 of the template and using the stop bracket 49 at the other end of the template for placing the slat 2 precisely before cutting,

FIG. 16(A) illustrates the placement of the adapted slats 2 on the ladder cords 6. The slat is pushed from the side into the appropriate position on the ladder cords. Placement of a few of the slats at the lowermost portion of the Venetian blind is advantageously postponed till after the bottom bracket 8 and weight body 15 shown in FIG. 16(B) have been mounted at the lower end of the ladder and lift cords.

As shown in FIGS. 16(A) and (B), the slats 2 are provided with an indentation or notch 45 for proper longitudinal positioning of each of the slats on the ladder cords 6.

As the final steps of assembling the Venetian blind, the bracket 8 and the weight body 15 are placed at the lowermost end of the Venetian blind (instead of a traditional bottom rail, although a traditional bottom rail could also have been used as an alternative to the bracket 8 and the weight body 15). The portions of ladder cords and lift cords beneath the bracket and weight body can finally by cut off.

It is understood that although the use of the template according to the invention has been illustrated in connection with a specific design of Venetian blind, it could also be used with other designs of Venetian blinds and also for adapting other devices to the specific dimensions and characteristics of for instance a window opening.

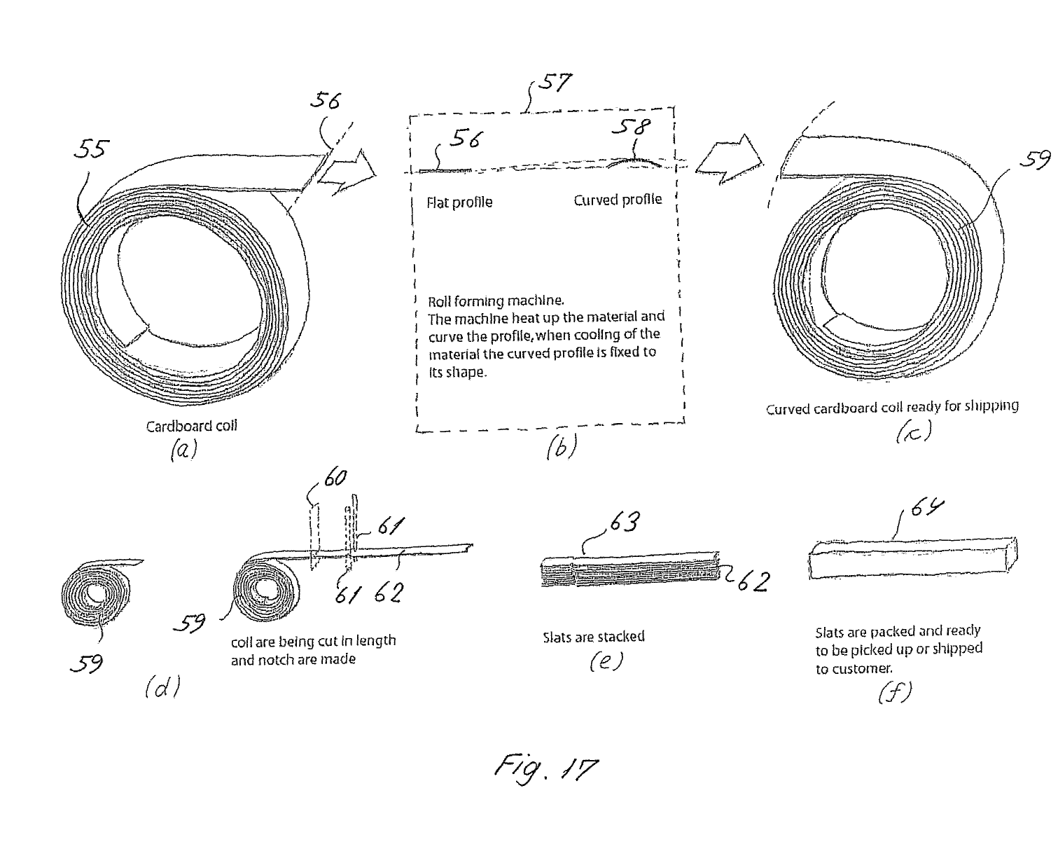

Referring to FIG. 17, the method for cardboard slat production according to an embodiment of the invention is illustrated. A material that can be used in the method according to the invention is commercially available from the company Iggesund Paperboard (www.iggesund.com) under the trade name “Invercote”, but the application of this specific material is only to be regarded as a non-limiting example of a material that is suitable for application in the inventive method,

A roll of cardboard 55 (FIG. 17(a)) with a substantially plane cross section as indicated by reference numeral 56 is provided to a roll-forming machine 57. The machine heats up the material and curves the profile, and when the material is subsequently cooled, the shape of the curved profile indicated by 58 in FIG. 17(b) is fixed. The processed cardboard sheet with the curved profile can be rolled up as indicated by 59, ready for shipment.

FIG. 17(d) illustrates the subsequent processing of the rolled up curved profile sheet 59 used for forming individual slats. The roll of material is cut into pieces of the appropriate length by cutting means 60, and indentations or notches can be provided in the longitudinal edge portions of the slat by cutting and corresponding guide means 61. The finished slats can be stacked 63 and packed 64 ready to be picked up or shipped to a customer.

1-38. (canceled)

39. An adjustment and fixing bracket for a Venetian blind comprising a bracket portion formed for releasable attachment to ladder cords or lift cords or both ladder and lift cords of a Venetian blind, and a weight body, the bracket portion being provided with means for releasable attachment of said weight body to said bracket portion.

40. The adjustment and fixing bracket according to claim 39, wherein said bracket portion comprises a central portion, at either longitudinal ends of which there is provided an end portion pivotably connected to the respective end of said central portion via respective hinge portions.

41. The adjustment and fixing bracket according to claim 39, wherein said central portion is provided with resilient engagement means for releasable attachment of said weight body to the bracket portion.

42. The adjustment and fixing bracket according to claim 39, further comprising a cover part of such a shape that said bracket portion and said weight body can be releasably covered by said cover portion.

43. The adjustment and fixing bracket according to claim 39, wherein the adjustment and fixing bracket is mounted beneath the lowermost slat of a Venetian blind having ladder (tilt) cords and lift cords.

44. A method of adjusting and fixing the slats of a Venetian blind comprising the following steps of:
(a) providing pairs of ladder (tilt) cords and lift cords extending downwards from a top profile (head rail) of a Venetian blind;
(b) at the desired distance below said top profile (head rail) providing a releasable bracket portion on said cords;
(c) releasably fixing said bracket portion to said cords at said distance below the top profile (head rail);
(d) releasably providing a weight body on said bracket portion.

45. A lift mechanism for a Venetian blind that comprises pairs of lift cords for raising or lowering the slats of the Venetian blind, the lift mechanism comprising two cone or drum portions, upon an outer circumferential surface of one of these portions one lift cord of a given pair of lift cords is wound upon rotation in a first direction of the drum portion and from which the lift cord is unwound upon rotation in an opposite second direction of the drum portion, and upon an outer circumferential surface of the other cone or drum portion, the other lift cord of a given pair of lift cords is wound upon rotation in said first direction of this other drum portion and from which the lift cord is unwound upon rotation in said opposite second direction of this drum portion.

46. The lift mechanism of claim 45, in which said lift cords pass through lift cord guide channels extending substantially tangentially to the corresponding outer circumferential surface of each respective cone or drum portion.

47. The lift mechanism of claim 45, in which said two cone or drum portions are connected through a central connection, such that they rotate with each other.

48. The lift mechanism of claim 45, in which said two cone or drum portions are provided coaxially with each other.

49. The lift mechanism of claim 45, in which there is provided a central portion, in which tilt cords are operatively coupled to said central connection.

50. The lift mechanism of claim 45, in which at least a portion of the outer circumferential surface of the cone or drum portions is covered by a cover, thereby forming a radial gap between the cover and the outer circumferential surface of the cone or drum portions, through which gap the respective lift cord passes.

51. The lift mechanism according to claim 50, wherein the width of said gap is substantially equal to or less than the diameter of said lift cord.

52. The lift mechanism according to claim 45, wherein said cone or drum portions are substantially cylindrical or conical.

53. The lift mechanism according to claim 45, wherein said cone or drum portions comprise a first drum portion upon which the lift cord is wound or from which it is unwound and a second drum portion extending longitudinally from the first drum portion, to which second drum portion the lift cord is attached, wherein the first drum portion is substantially cylindrical or conical and where the cross sectional shape of the second portion is such that the circumference of the cross section is less than the circumference of the cylindrical portion.

54. The lift mechanism according to claim 53, wherein the second drum portion has a cross section, whose boundary is piecewise linear.

55. The lift mechanism according to claim 53, wherein the boundary of the cross section of the second drum portion comprises curved portions.

56. The lift mechanism according to claim 53, wherein said cross sectional shape is hexagonal, triangular, square or formed as an asterisk.

57. The lift mechanism according to claim 53, wherein the cross section of the second drum portion is circular over one or more angular sections θᵢ, and non-circular over one or more other angular sections φⱼ.

58. The lift mechanism according to claim 45, wherein said cone or drum portions are provided with a shoulder portion substantially at the longitudinal end of the cone or drum portion where the lift cord is wound on/off the cone or drum portion from the slats, by means of which shoulder portion the turns of the lift cord are pushed in the direction away from the shoulder portion when the lift cord is wound upon the cone or drum portion.

59. The lift mechanism according to claim 45, wherein an end face of the retaining means on the guide bracket acts as abutment means for pushing the turns of the lift cord in the direction away from the end face, when the lift cord is wound upon the cone or drum portion.
